(19) United States
(12) Patent Application Publication
(10) Pub. No.: US 2026/0248118 A1
(43) Pub. Date: Aug. 27, 2026

(54) FISHING GEAR STORAGE BOX

(71) Applicant: Yehua Wu, Yuyao (CN)

(72) Inventor: Yehua Wu, Yuyao (CN)

(21) Appl. No.: 19/313,862

(22) Filed: Aug. 29, 2025

(30) Foreign Application Priority Data
Feb. 27, 2025 (CN) 202520322365.X
Apr. 3, 2025 (CN) 202520619503.0
May 14, 2025 (CN) 202520944333.3
May 19, 2025 (CN) 202520979422.1

(51) Int. Cl. A01K 97/06

(52) U.S. Cl. CPC A01K 97/06

(57) ABSTRACT

The present invention discloses a fishing gear storage box, comprising a storage box body. The storage box body has a single structure or a multi-layer structure formed by a plurality of storage box bodies spliced and combined together. The storage box body comprises a box body and a flip cover rotatably connected to the upper end of the box body. One or a plurality of freely combinable fishing gear racks are detachably installed in the box body. The various fishing gear racks of the present invention can be used in combination, and can be matched into appropriate modular combinations according to fishing environments, fishing habits and selection of fish species.

### CROSS-REFERENCE TO RELATED APPLICATIONS

This application claims priority to Chinese Patent Application No. 202520979422.1, filed on May 19, 2025, and claims priority to Chinese Patent Application No. 202520944333.3, filed on May 14, 2025, and claims priority to Chinese Patent Application No. 202520322365.X, filed on Feb. 27, 2025, and claims priority to Chinese Patent Application No. 202520619503.0, filed on Apr. 3, 2025, the entire contents of which is hereby incorporated by reference in its entirety.

### TECHNICAL FIELD

The present invention relates to a storage box, in particular to a fishing gear storage box.

### BACKGROUND

Fishing is increasingly becoming a popular sport among people. The obsession with this sport is biologically attributed to the awakening of the ancient hunting genes that exist within humans. Physiologically speaking, this sport can provide dopamine that brings physical and mental pleasure. With the progress of the times and the research on the living habits of various fish species, all kinds of fishing gear have emerged like mushrooms after rain, which, of course, are fishing strategies formed for different fish species and individual sizes in different environments. In other words, fishing has become more targeted, and targeted fishing gear under subdivision become more and more. The diversity of fishing gear means that anglers need to carry more fishing gear, which further tests the ability of anglers to carry, store and organize fishing gear. Conventionally, each type of fishing gear requires a packing box for storage. For multiple types of fishing gear, it will be extremely complicated. Both in terms of carrying and using, it is very complicated. If multiple types of fishing gear are integrated into one fishing gear box, it is also necessary to consider the situation where fishing gear supplies are prone to entanglement and tangling during storage. For example, metal jigs, VIB baits and other artificial baits in Lure fishing gear which are not properly stored may waste fishing time and affect fishing mood, or even cause the situation where fishhooks prick hands due to the disorder.

Fishing gear supplies need a good storage environment. Traditional fishing gear boxes, especially those for Lure artificial baits, adopt fixed partitioned storage, with artificial baits of the same size placed in the same area. Such design neglects the problem of disorder among fishing gear, which poses a safety hazard that hands are easy to be pricked by fishhook tips when taking fishing gear. Moreover, once the boxes overturns, the artificial baits inside will surely spill all over the ground, that is, the stability of fishing gear placement is poor. A fishing gear box with a reasonable storage structure can avoid the disorder among fishing gear, the occupation of space in the fishing gear box and the inconvenience of taking out fishing gear.

In the current era when fishing is becoming increasingly popular, fishing gear, as an indispensable tool for fishing activities, is constantly growing in both variety and quantity. The fishing gear, from common fishing hooks and lines to various artificial baits such as metal jigs and rubber jigs, not only offer fishing enthusiasts plenty of choices, but also bring many challenges to the storage of fishing gear. At present, a wide variety of fishing gear storage products exist on the market, but most of the storage products have some obvious defects. On one hand, the existing storage boxes have relatively simple structural design, usually only have simple storage space and lack the function of classifying and orderly storing different types of fishing gear. This leads to the fact that during the storage process, various kinds of fishing gear are prone to mutual entanglement and extrusion, which not only affects the service life of the fishing gear, but also makes it extremely inconvenient to find specific fishing gear, wasting a lot of time and energy of anglers. Common metal jigs, as an example, have different length specifications. Longer metal jigs are difficult to be properly placed in ordinary storage boxes and prone to shaking in the storage boxes and collision with other fishing gear, causing wear and even damage to the surface coating of the metal jigs and affecting the using effect. For artificial baits like rubber jigs that have specific shapes and structures, the existing storage boxes often fail to provide appropriate fixing modes, causing rubber jigs to be placed randomly in the storage boxes, which increases the risk of damage to fishhook tips and also affects the rational utilization of the internal space of the storage boxes.

Traditional fishing gear boxes, especially those for Lure artificial baits, adopt fixed partitioned storage, with artificial baits of the same size placed in the same area. Such design neglects the problem of disorder among fishing gear, which poses a safety hazard that hands are easy to be pricked by fishhook tips when taking fishing gear. Moreover, once the boxes overturns, the artificial baits inside will surely spill all over the ground. For example, when fly tying hooks are to be stored, thin boxes are available on the market, with the disadvantages of single items contained, disorderly placement and irregularity, and thick boxes are also available, but the space utilization rate is relatively low, with a lot of space not utilized.

### SUMMARY

In view of the defects in the prior art, the purpose of the present invention is to provide a fishing gear storage box.

The technical solution of the present invention is as follows: a fishing gear storage box, comprising a storage box body. The storage box body has a single structure or a multi-layer structure formed by a plurality of storage box bodies spliced and combined together. The storage box body comprises a box body and a flip cover rotatably connected to the upper end of the box body. One or a plurality of freely combinable fishing gear racks are detachably installed in the box body.

Further, protruding strips are convexly arranged on the front, rear, left and right inner walls of the box body respectively, grooves are formed between adjacent protruding strips, the upper ends of the grooves are open, both ends of the fishing gear rack are convexly provided with a clamping strip respectively, and the grooves are for the clamping strips to be clamped in.

Further, a first fishing gear rack is detachably installed in the box body, the first fishing gear rack is provided with a plurality of first clamping grooves with upward openings, the first fishing gear rack is composed of a base and soft rubber fixed on the base, and the first clamping grooves are arranged on the soft rubber.

Further, a second fishing gear rack is detachably installed in the box body, the second fishing gear rack is composed of a first placing rack and a second placing rack, the first placing rack is provided with a plurality of separation cavities with upward openings, and the second placing rack is provided with a plurality of notches facing upwards and separation grooves located to the right of the notches; and the upper end of the first placing rack is hinged with a pressure plate for blocking the openings at the upper ends of the separation cavities.

Both ends of the first fishing gear rack, both ends of the first placing rack and both ends of the second placing rack are convexly provided with a clamping strip respectively, and the grooves are for the clamping strips to be clamped in.

Further, the outer side of the box body is convexly provided with a plurality of mounting columns.

The left side and the right side of the front end of the box body are respectively provided with a belt hole, and the two belt holes are used to hang belts.

The left end, the right end and the front end of the box body are respectively provided with a flip cover buckle for clamping the flip cover, and a buckle groove for the outer edge of the flip cover to be clamped in is formed between the inner side of the flip cover buckle and the top of the box body.

Further, the front end and the rear end of the flip cover are respectively provided with clamping holes and bayonets, the rear lower end of the box body is provided with first clamping hooks, the front end of the box body is hinged with buttons, the lower end of each button is provided with a second clamping hook, and when the storage box body has a multi-layer structure formed by a plurality of storage box bodies spliced and combined together, the first clamping hooks and the second clamping hooks of the box body of one of the two adjacent storage box bodies are respectively clamped in the clamping holes and the bayonets of the flip cover of the other storage box body.

Further, a third fishing gear rack is detachably installed in the box body, the third fishing gear rack comprises a first clamping plate and a second clamping plate located to the left of the first clamping plate, the first clamping plate is provided with a plurality of first positioning grooves and second positioning grooves, the left ends, the right ends and the upper ends of the first positioning grooves and the second positioning grooves are all open, the first positioning grooves and the second positioning grooves are evenly spaced from front to back, the inner wall of the upper end of each first positioning groove is convexly provided with first buckle points, the second clamping plate is provided with a plurality of third positioning grooves and fourth positioning grooves, the left ends, the right ends and the upper ends of the third positioning grooves and the fourth positioning grooves are all open, the third positioning grooves and the fourth positioning grooves are evenly spaced from front to back, the inner wall of the upper end of each fourth positioning groove is convexly provided with second buckle points, the first positioning grooves are arranged in alignment with the third positioning grooves, and the second positioning grooves are arranged in alignment with the fourth positioning grooves.

Further, a fourth fishing gear rack is detachably installed in the box body, the fourth fishing gear rack comprises a third clamping plate and a fourth clamping plate located to the left of the third clamping plate, the third clamping plate is provided with a plurality of fifth positioning grooves distributed front and back, the fourth clamping plate is provided with a plurality of sixth positioning grooves distributed front and back, the fifth positioning grooves are arranged in alignment with the sixth positioning grooves, and the left ends, the right ends and the upper ends of the fifth positioning grooves and the sixth positioning grooves are all open.

Further, a partition plate extending front and back is arranged in the third fishing gear rack, and the partition plate is located between the first clamping plate and the second clamping plate.

Further, the fourth fishing gear rack is provided with a first containing groove with an upward opening, and the first containing groove is located to the left of the fourth clamping plate.

Further, a fifth fishing gear rack is detachably installed in the box body, the fifth fishing gear rack is detachably connected with the grooves, and the upper end of the fifth fishing gear rack is provided with a plurality of fixing clips distributed left and right.

Further, a sixth fishing gear rack is detachably installed in the box body, the sixth fishing gear rack is detachably connected with the grooves, the sixth fishing gear rack comprises a fifth clamping plate, a sixth clamping plate and a seventh clamping plate distributed from front to back, the fifth clamping plate is provided with a plurality of first mounting grooves distributed left and right, the sixth clamping plate is provided with a plurality of second mounting grooves distributed left and right, the seventh clamping plate is provided with a plurality of third mounting grooves distributed left and right, the front ends, the rear ends and the upper ends of the first mounting grooves, the second mounting grooves and the third mounting grooves are all open, and the second mounting grooves are arranged in alignment with the first mounting grooves and the third mounting grooves.

Further, a seventh fishing gear rack is detachably installed in the box body, the seventh fishing gear rack is located in front of the fifth fishing gear rack, the seventh fishing gear rack is provided with a plurality of fourth mounting grooves distributed left and right, the front ends, the rear ends and the upper ends of the fourth mounting grooves are all open, and the fourth mounting grooves are arranged in alignment with the fixing clips.

Further, the left end and the right end of the fifth fishing gear rack are convexly provided with third clamping strips, the left end and the right end of the sixth fishing gear rack are convexly provided with fourth clamping strips, the left end and the right end of the seventh fishing gear rack are convexly provided with fifth clamping strips, and the grooves are for the third clamping strips, the fourth clamping strips and the fifth clamping strips to be clamped in.

The sixth fishing gear rack is provided with a second containing groove with an upward opening, the second containing groove is extended from the left end to the right end of the sixth fishing gear rack, and the second containing groove is located between the sixth clamping plate and the seventh clamping plate.

The upper end of the seventh clamping plate is provided with a plurality of stoppers distributed left and right, and the stoppers are extended forwards above the second containing groove.

Further, an eighth fishing gear rack is installed in the box body, the left end and the right end of the eighth fishing gear rack are respectively provided with a sixth clamping strip, and the sixth clamping strips are clamped in the grooves; the eighth fishing gear rack comprises a bracket, and a plurality of rows of second clamping grooves for clamping fly tying hooks are distributed on the outer wall of the bracket; the left end and the right end of the bracket are respectively provided with a turntable, the outer sides of the two turntables are respectively provided with a fixing plate, and the turntables are rotatably connected with the fixing plates; and the sixth clamping strips are convexly arranged on the outer sides of the fixing plates.

Further, the inner sides of the two fixing plates are respectively provided with an insertion column extending left and right, the centers of the two turntables are respectively provided with an insertion hole extending left and right, and the insertion column is inserted into the insertion hole and rotatably matched with the insertion hole.

Further, the ends of the insertion column are provided with buckles, and the buckles are clamped on the inner wall of the insertion hole.

Further, the outer sides of the two turntables are respectively provided with a first convex ring, the inner sides of the two fixing plates are respectively provided with a second convex ring, and the second convex ring is sleeved outside the first convex ring.

Further, a plurality of circular grooves are evenly distributed on the outer wall of the first convex ring along the circumference, each fixing plate is provided with two resilient pieces, the inner sides of the two resilient pieces are convexly provided with a resilient point respectively, and the circular grooves are for the resilient points to be clamped in.

The fishing gear storage box provided by the present invention has the following advantageous effects:

With the design of a single structure or a multi-layer structure formed by a plurality of storage box bodies spliced and combined together, the fishing gear storage box can flexibly adapt to the storage of different quantities and types of fishing gear, and users can choose to use fishing gear separately or in combination according to the types and quantities needed for actual fishing activities, which greatly improves the storage efficiency and carrying convenience of fishing gear.

The first fishing gear rack and the second fishing gear rack are arranged in the storage box body, wherein the first fishing gear rack is provided with a plurality of first clamping grooves with upward openings for clamping fishing gear such as Lure metal jigs and VIB, the second fishing gear rack is used to hold heads and tails of fishing gear such as Lure pencils and Minnow, the tails are clamped in the notches, the fishhooks are placed in the separation grooves, the heads are clamped in the separation cavities of the first placing rack to prevent the fishhooks from hooking with each other, and this partition design effectively avoids entanglement and tangling among fishing gear and ensures that the fishing gear is neatly arranged.

The third fishing gear rack can be used to neatly hold a plurality of jig heads, the fourth fishing gear rack can be used to neatly hold a plurality of rubber jigs, and the jig heads and the rubber jigs are not easy to drop.

The fixing clips of the fifth fishing gear rack can be used separately to champ metal jigs or in combination with the seventh fishing gear rack, and the combined use is for longer metal jigs, where one end can be clamped in the fixing clips and the other end is clamped in the fourth mounting groove; and the sixth fishing gear rack is used to hold rubber jigs. Users can make various combinations of the fishing gear racks according to different fishing environments, fish species, fishing habits, etc. Compared with common single fishing gear boxes or fishing gear boxes with fishing gear disorderly placed, the present invention has high adaptability and diverse combined modes, which can meet the carrying requirements of different fishing baits. The combined modes absolutely can be matched according to the environment and personal preferences.

With the arrangement of a plurality of rows of second clamping grooves for clamping fly tying hooks on the outer wall of the bracket, the fly tying hooks can be placed neatly and orderly, which avoids the problem of messy placement of fly tying hooks in traditional fixed partitioned storage, making the storage more tidy and facilitating users to quickly find the fly tying hooks required; and the space utilization rate is high, the bracket can be rotated, and when users need to take out fly tying hooks placed in different positions, only the eighth fishing gear rack needs rotating, without the need to turn over the entire storage box or change the placement direction thereof, which greatly improves the convenience of taking out the fly tying hooks.

### BRIEF DESCRIPTION OF DRAWINGS

FIG. 1 is a diagram of an open state of embodiment 1 of the present invention;

FIG. 2 is a structural schematic diagram of a box body of embodiment 1 of the present invention;

FIG. 3 is a schematic diagram of one closed state of embodiment 1 of the present invention;

FIG. 4 is a schematic diagram of another closed state of embodiment 1 of the present invention;

FIG. 5 is a structural schematic diagram of a first fishing gear rack and a second fishing gear rack of the present invention;

FIG. 6 is a schematic diagram of a spliced and combined state of a plurality of storage box bodies of embodiment 1 of the present invention;

FIG. 7 is a schematic diagram of an open state of embodiment 2 of the present invention;

FIG. 8 is a schematic diagram of an open state of embodiment 3 of the present invention;

FIG. 9 is a schematic diagram of an open state of embodiment 4 of the present invention;

FIG. 10 is a schematic diagram of a spliced and combined state of a plurality of storage box bodies of embodiment 5 of the present invention;

FIG. 11 is an overall structural schematic diagram of embodiment 6 of the present invention;

FIG. 12 is a structural schematic diagram of a box body of embodiment 6 of the present invention;

FIG. 13 is a structural schematic diagram of a third fishing gear rack and a fourth fishing gear rack of embodiment 6 of the present invention;

FIG. 14 is an overall structural schematic diagram of embodiment 7 of the present invention;

FIG. 15 is an overall structural schematic diagram of embodiment 8 of the present invention;

FIG. 16 is an overall structural schematic diagram of embodiment 9 of the present invention;

FIG. 17 is a structural schematic diagram of a fifth fishing gear rack, a sixth fishing gear rack and a seventh fishing gear rack of the present invention;

FIG. 18 is an overall structural schematic diagram of embodiment 10 of the present invention;

FIG. 19 is an overall structural schematic diagram of embodiment 11 of the present invention;

FIG. 20 is an overall structural schematic diagram of embodiment 12 of the present invention;

FIG. 21 is an overall structural schematic diagram of embodiment 13 of the present invention;

FIG. 22 is a structural schematic diagram of an eighth fishing gear rack of embodiment 13 of the present invention;

FIG. 23 is an exploded schematic diagram of an eighth fishing gear rack of embodiment 13 of the present invention;

FIG. 24 is a structural schematic diagram of an eighth fishing gear rack of embodiment 14 of the present invention;

FIG. 25 is a structural schematic diagram of an eighth fishing gear rack of embodiment 15 of the present invention;

FIG. 26 is a structural schematic diagram of an eighth fishing gear rack of embodiment 16 of the present invention;

FIG. 27 is a structural schematic diagram of an eighth fishing gear rack of embodiment 17 of the present invention.

In the figures: 100—storage box body, 1—box body, 2—flip cover, 3—first fishing gear rack, 31—first clamping groove, 32—base, 33—soft rubber, 4—second fishing gear rack, 41—first placing rack, 411—separation cavity, 412—pressure plate, 42—second placing rack, 421—notch, 422—separation groove, 5—mounting column, 6—belt hole, 7—belt, 8—flip cover buckle, 9—buckle groove, 10—protruding strip, 11—groove, 12—clamping strip, 13—clamping hole, 14—bayonet, 15—first clamping hook, 16—button, 161—second clamping hook, 17—third fishing gear rack, 171—first clamping plate, 1711—first positioning groove, 17111—first buckle point, 1712—second positioning groove, 172—second clamping plate, 1721—third positioning groove, 1722—fourth positioning groove, 17221—second buckle point, 173—first clamping strip, 174—partition plate, 18—fourth fishing gear rack, 181—third clamping plate, 1811—fifth positioning groove, 18111—third buckle point, 182—fourth clamping plate, 1821—sixth positioning groove, 183—second clamping strip, 184—first containing groove, 19—jig head, 20—fifth fishing gear rack, 201—fixing clip, 2011—third clamping strip, 21—sixth fishing gear rack, 211—fifth clamping plate, 2111—first mounting groove, 21111—fourth buckle point, 212—sixth clamping plate, 2121—second mounting groove, 213—seventh clamping plate, 2131—third mounting groove, 2132—stopper, 214—fourth clamping strip, 215—second containing groove, 22—seventh fishing gear rack, 221—fourth mounting groove, 222—fifth clamping strip, 23—eighth fishing gear rack, 231—bracket, 2311—second clamping groove, 2312—turntable, 23121—insertion hole, 23122—first convex ring, 231221—circular groove, 232—fixing plate, 2321—sixth clamping strip, 2322—insertion column, 23221—buckle, 2323—second convex ring, 2324—resilient piece, 23241—resilient point, and 24—fly tying hook.

### DESCRIPTION OF EMBODIMENTS

In order to understand the technical solution of the present invention more intuitively and completely, the non-restrictive features are described as follows in combination with the drawings of the present invention:

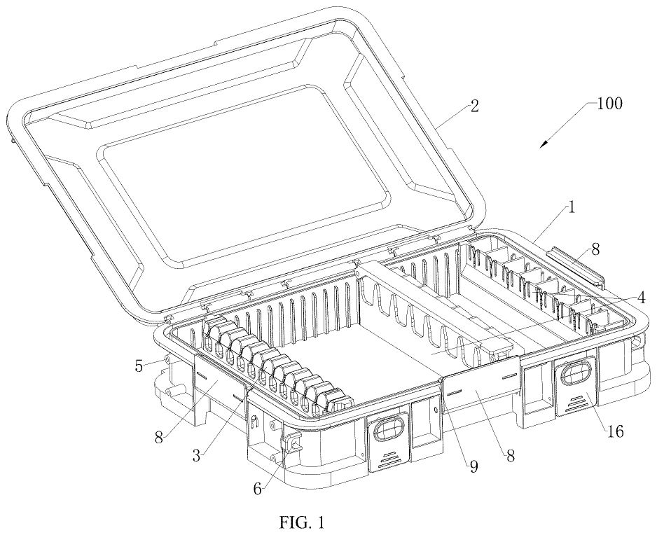

Embodiment 1: As shown in FIG. 1 to FIG. 6, a fishing gear storage box comprises a storage box body 100, the storage box body 100 has a single structure or a multi-layer structure formed by a plurality of storage box bodies 100 spliced and combined together, the storage box body 100 comprises a box body 1 and a flip cover 2 rotatably connected to the upper end of the box body 1, a first fishing gear rack 3 and a second fishing gear rack 4 are detachably installed in the box body 1, the first fishing gear rack 3 is provided with a plurality of first clamping grooves 31 with upward openings, the second fishing gear rack 4 is composed of a first placing rack 41 and a second placing rack 42, the first placing rack 41 is provided with a plurality of separation cavities 411 with upward openings, and the second placing rack 42 is provided with a plurality of notches 421 facing upwards and separation grooves 422 located to the right of the notches 421.

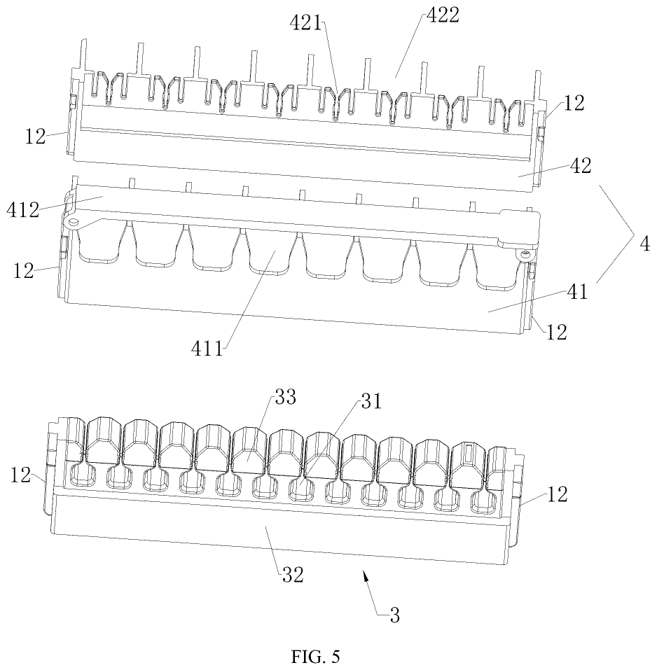

As shown in FIG. 5, the upper end of the first placing rack 41 is hinged with a pressure plate 412 for blocking the openings at the upper ends of the separation cavities 411. The arrangement of the pressure plate 412 is to prevent the fishing gear from falling off.

As shown in FIG. 1, the outer side of the box body 1 is convexly provided with a plurality of mounting columns 5. The mounting columns 5 are used to connect external items such as fishing rod tubes and pliers fixing brackets.

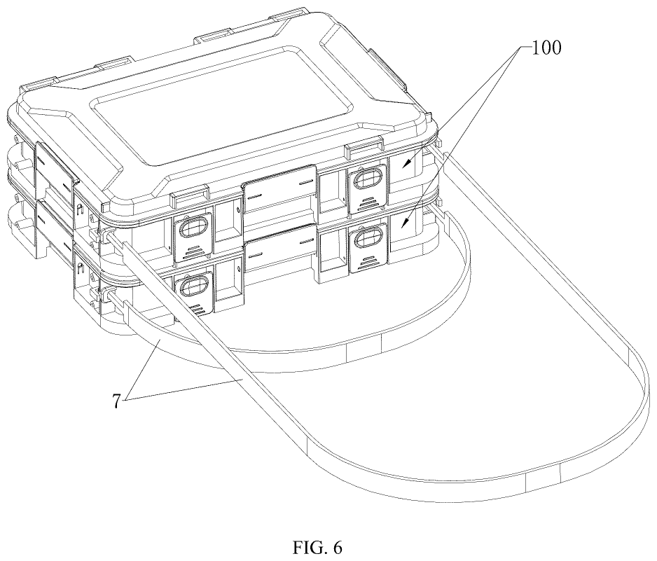

As shown in FIG. 1 and FIG. 6, the left side and the right side of the front end of the box body 1 are respectively provided with a belt hole 6, and the two belt holes 6 are used to hang belts 7. The belts 7 have two sizes: long and short, the short belt can be carried by hand, and the long belt can be carried on the back.

As shown in FIG. 1, the left end, the right end and the front end of the box body 1 are respectively provided with a flip cover buckle 8 for clamping the flip cover 2, and a buckle groove 9 for the outer edge of the flip cover 2 to be clamped in is formed between the inner side of the flip cover buckle 8 and the top of the box body 1.

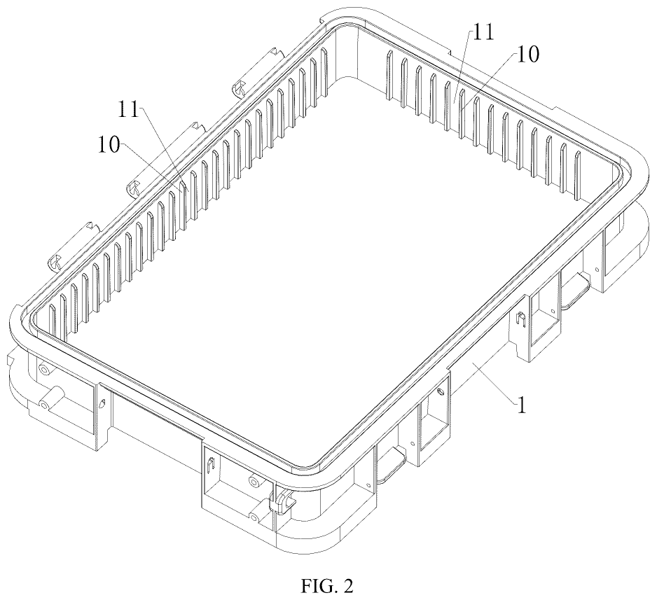

As shown in FIG. 2 and FIG. 5, protruding strips 10 are convexly arranged on the front, rear, left and right inner walls of the box body 1 respectively, grooves 11 are formed between adjacent protruding strips 10, the upper ends of the grooves 11 are open, both ends of the first fishing gear rack 3, both ends of the first placing rack 41 and both ends of the second placing rack 42 are convexly provided with a clamping strip 12 respectively, and the grooves 11 are for the clamping strips 12 to be clamped in.

As shown in FIG. 5, the first fishing gear rack 3 is composed of a base 32 and soft rubber 33 fixed on the base 32, the first clamping grooves 31 are arranged on the soft rubber 33, and soft materials are easy for fishing gear to be clamped in.

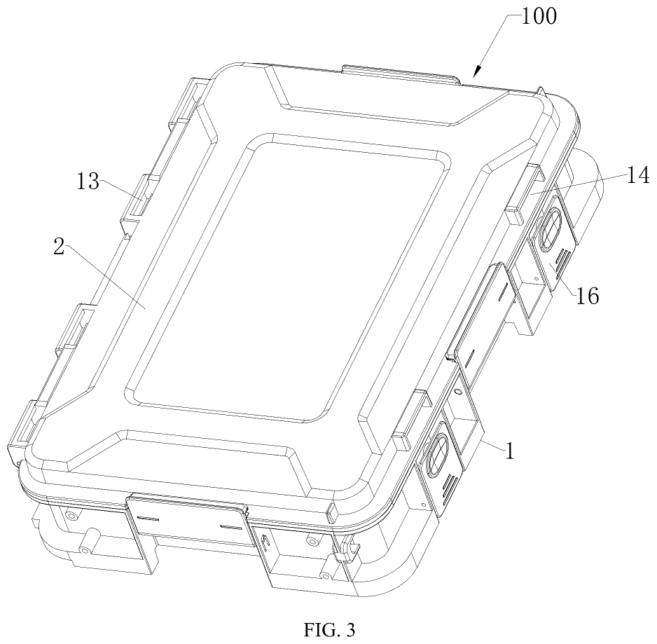

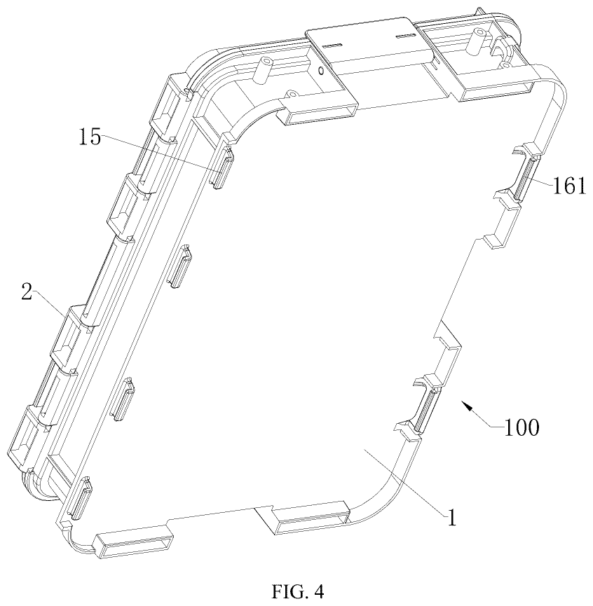

As shown in FIG. 3, FIG. 4 and FIG. 6, to facilitate the splicing and combination of the storage box bodies 100, the front end and the rear end of the flip cover 2 are respectively provided with clamping holes 13 and bayonets 14, the rear lower end of the box body 1 is provided with first clamping hooks 15, the front end of the box body 1 is hinged with buttons 16, the lower end of each button 16 is provided with a second clamping hook 161, and when the storage box body 100 has a multi-layer structure formed by a plurality of storage box bodies 100 spliced and combined together, the first clamping hooks 15 and the second clamping hooks 161 of the box body 1 of one of the two adjacent storage box bodies 100 are respectively clamped in the clamping holes 13 and the bayonets 14 of the flip cover 2 of the other storage box body 100. A spring (not shown in the figure) for the resetting of the button 16 is installed between the button 16 and the box body 1. After the upper end of the button 16 is pressed backwards, the second clamping hooks 161 will disengage from the bayonets 14, facilitating the removal of the storage box body 100. After the plurality of storage box bodies 100 are spliced and combined together, one of the storage box bodies 100 and the flip cover 2 can be opened separately, and only the corresponding flip cover buckle 8 needs breaking off with hands.

The present invention can achieve efficient storage and carrying: with the design of a single structure or a multi-layer structure formed by a plurality of storage box bodies 100 spliced and combined together, the fishing gear storage box can flexibly adapt to the storage of different quantities and types of fishing gear, and users can choose to use fishing gear separately or in combination according to the types and quantities needed for actual fishing activities, which greatly improves the storage efficiency and carrying convenience of fishing gear.

The present invention has reasonable partitioning to avoid disorder: the first fishing gear rack 3 and the second fishing gear rack 4 are arranged in the storage box body 100, wherein the first fishing gear rack 3 is provided with a plurality of first clamping grooves 31 with upward openings for clamping fishing gear such as Lure metal jigs and VIB, the second fishing gear rack 4 is used to hold heads and tails of fishing gear such as Lure pencils and Minnow, the tails are clamped in the notches 421, the fishhooks are placed in the separation grooves 422, the heads are clamped in the separation cavities 411 of the first placing rack 41 to prevent the fishhooks from hooking with each other, and this partition design effectively avoids entanglement and tangling among fishing gear and ensures that the fishing gear is neatly arranged.

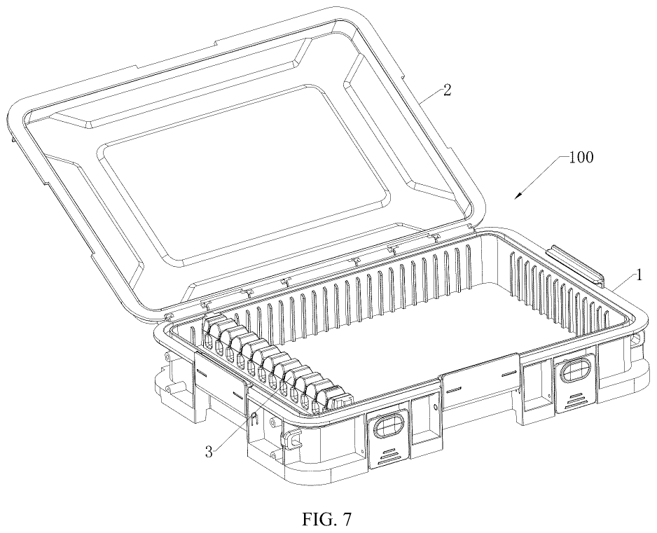

Embodiment 2: As shown in FIG. 7, embodiment 2 is different from embodiment 1 in that: a first fishing gear rack 3 is detachably installed in the box body 1, without a second fishing gear rack 4.

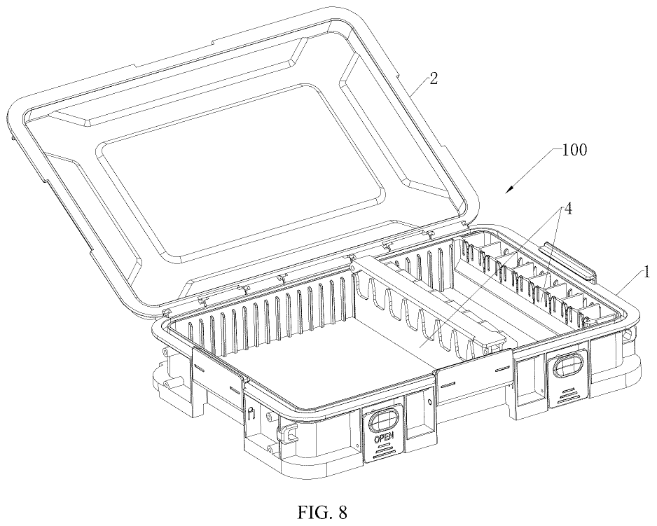

Embodiment 3: As shown in FIG. 8, embodiment 3 is different from embodiment 1 in that: a second fishing gear rack 4 is detachably installed in the box body 1, without a first fishing gear rack 3.

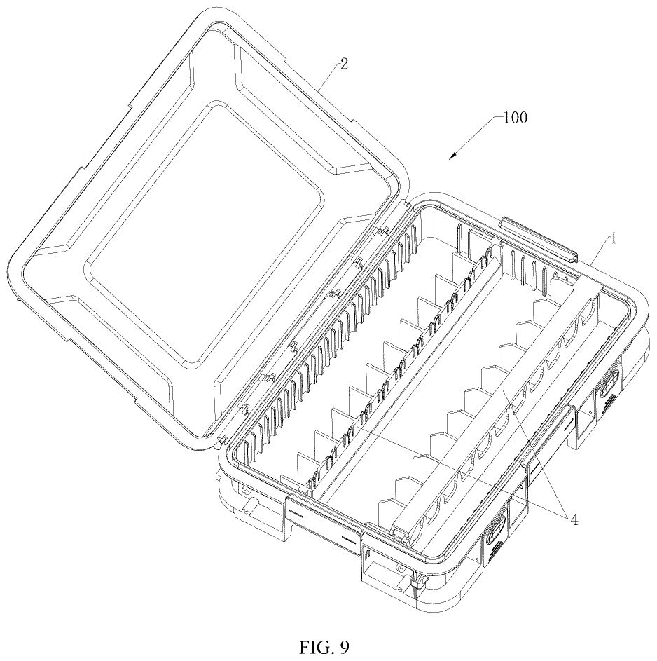

Embodiment 4: As shown in FIG. 9, embodiment 4 is different from embodiment 1 in that: a second fishing gear rack 4 is detachably installed in the box body 1, without a first fishing gear rack 3, and the second fishing gear rack 4 is installed by extending left and right, which is different from that the second fishing gear frame 4 in embodiment 1 is installed by extending front and back.

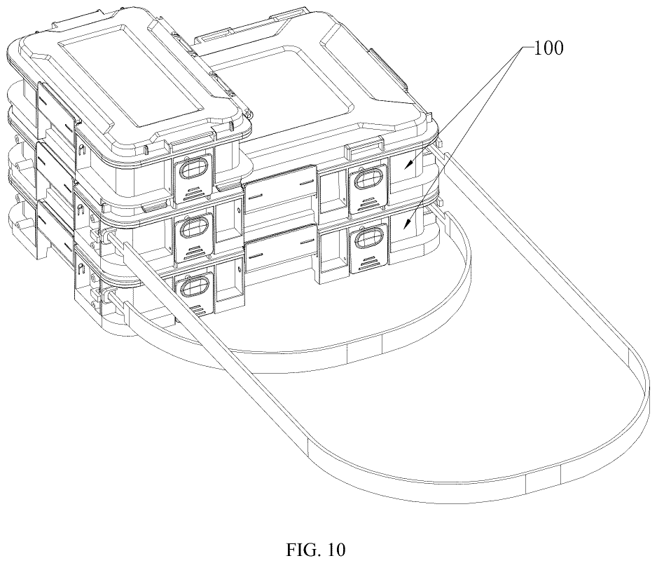

Embodiment 5: As shown in FIG. 10, embodiment 5 is different from embodiment 1 in that: when a plurality of storage box bodies 100 are spliced and combined together, small-volume (with the volume equal to half of that of large-volume storage box bodies 100) storage box bodies 100 can also be assembled.

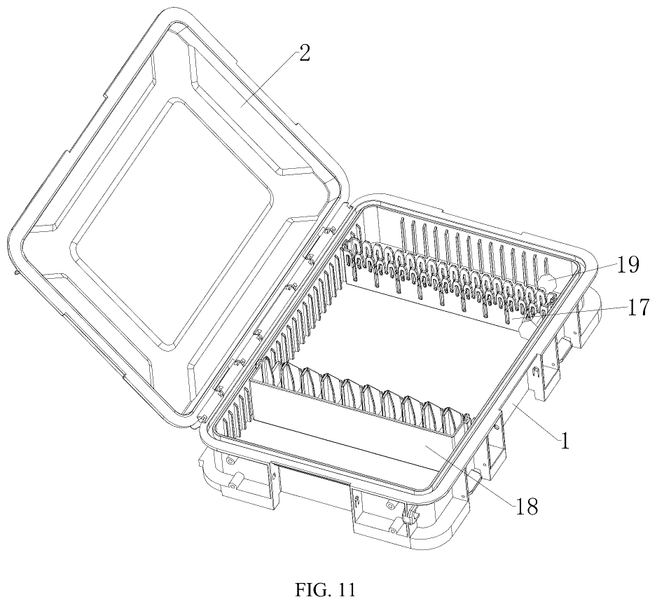

Embodiment 6: As shown in FIG. 11 to FIG. 13, a fishing gear storage box comprises a box body 1 and a flip cover 2 rotatably connected to the upper end of the box body 1, and a third fishing gear rack 17 and a fourth fishing gear rack 18 are detachably installed in the box body 1.

The third fishing gear rack 17 comprises a first clamping plate 171 and a second clamping plate 172 located to the left of the first clamping plate 171, the first clamping plate 171 is provided with a plurality of first positioning grooves 1711 and second positioning grooves 1712, the left ends, the right ends and the upper ends of the first positioning grooves 1711 and the second positioning grooves 1712 are all open, the first positioning grooves 1711 and the second positioning grooves 1712 are evenly spaced from front to back, the inner wall of the upper end of each first positioning groove 1711 is convexly provided with first buckle points 17111, the second clamping plate 172 is provided with a plurality of third positioning grooves 1721 and fourth positioning grooves 1722, the left ends, the right ends and the upper ends of the third positioning grooves 1721 and the fourth positioning grooves 1722 are all open, the third positioning grooves 1721 and the fourth positioning grooves 1722 are evenly spaced from front to back, the inner wall of the upper end of each fourth positioning groove 1722 is convexly provided with second buckle points 17221, the first positioning grooves 1711 are arranged in alignment with the third positioning grooves 1721, and the second positioning grooves 1712 are arranged in alignment with the fourth positioning grooves 1722.

The fourth fishing gear rack 18 comprises a third clamping plate 181 and a fourth clamping plate 182 located to the left of the third clamping plate 181, the third clamping plate 181 is provided with a plurality of fifth positioning grooves 1811 distributed front and back, the fourth clamping plate 182 is provided with a plurality of sixth positioning grooves 1821 distributed front and back, the fifth positioning grooves 1811 are arranged in alignment with the sixth positioning grooves 1821, and the left ends, the right ends and the upper ends of the fifth positioning grooves 1811 and the sixth positioning grooves 1821 are all open.

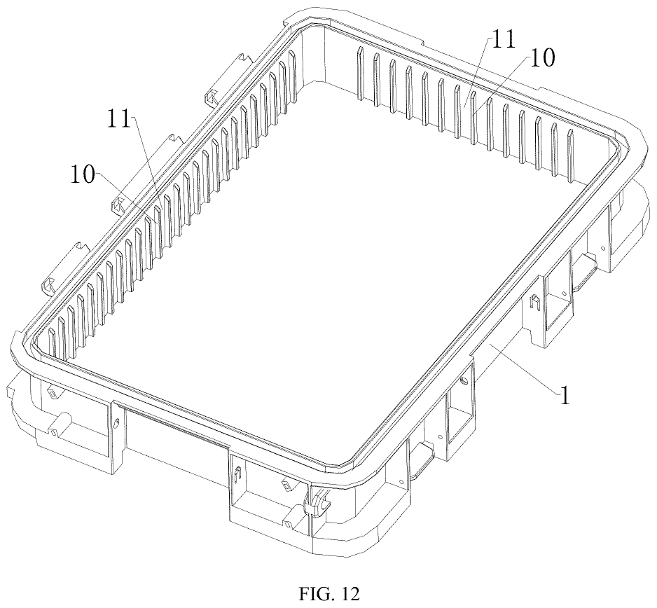

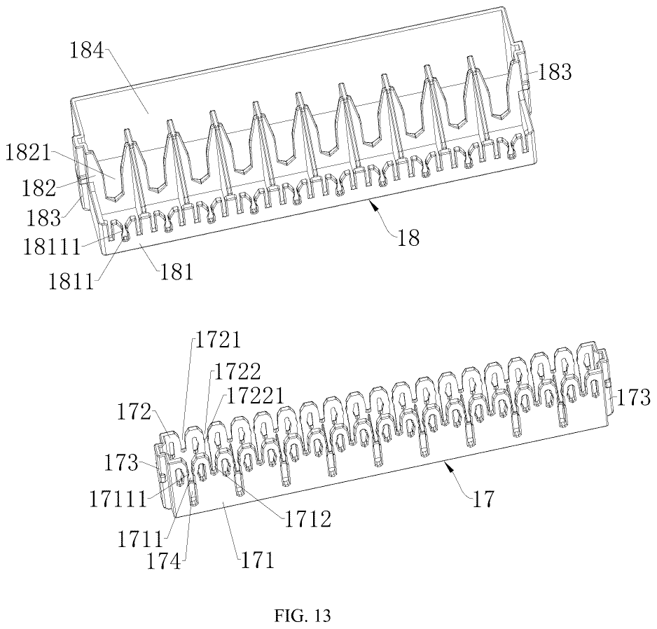

As shown in FIG. 12 and FIG. 13, to facilitate the installation and removal of the third fishing gear rack 17 and the fourth fishing gear rack 18, the front end and the rear end of the third fishing gear rack 17 are convexly provided with a first clamping strip 173 respectively, the front end and the rear end of the fourth fishing gear rack 18 are convexly provided with a second clamping strip 183 respectively, protruding strips 10 are convexly arranged on the front, rear, left and right inner walls of the box body 1 respectively, grooves 11 are formed between adjacent protruding strips 10, and the upper ends of the grooves 11 are open for the first clamping strips 173 and the second clamping strips 183 to be clamped in.

As shown in FIG. 13, a partition plate 174 extending front and back is arranged in the third fishing gear rack 17, and the partition plate 174 is located between the first clamping plate 171 and the second clamping plate 172. The arrangement of the partition plate 174 is to place jig heads 19, and the middle parts of the jig heads 19 are supported by the partition plate 174 so that the jig heads 19 can be placed more stably.

As shown in FIG. 13, the fourth fishing gear rack 18 is provided with a containing groove 184 with an upward opening, and the containing groove 184 is located to the left of the fourth clamping plate 182. The heads of rubber jigs can be placed in the containing groove 184.

When placed, the jig heads 19 can be clamped on the third fishing gear rack 17 in a staggered mode, as shown in FIG. 11 (that is, the head of one of the two jig heads 19 in FIG. 11 faces left, and the head of the other one faces right). When a first jig head 19 is placed, the head of the jig head 19 is exposed outside the left side of the second clamping plate 172, one end of the hook of the jig head 19 is clamped in the third positioning groove 1721 of the second clamping plate 172, the other end of the hook of the jig head 19 is clamped in the first positioning groove 1711, and the first buckle point 17111 will block the hook to prevent the jig head 19 from falling off. When a second jig head 19 is placed, the head of the jig head 19 is exposed outside the right side of the first clamping plate 171, one end of the hook of the jig head 19 is clamped in the second positioning groove 1712, the other end of the hook is clamped in the fourth positioning groove 1722, and the second buckle point 17221 will block the hook to prevent the jig head 19 from falling off. The remaining jig heads 19 are placed in this way. To remove a jig head 19, the head of the jig head 19 is pressed down by hand, then the hook will curl up, and after the hook disengages from the first buckle point 17111 or the second buckle point 17221, the jig head 19 can be removed.

To place a rubber jig, the head thereof is placed in the containing groove 184, one end of the hook is clamped in the sixth positioning groove 1821, the other end of the hook is clamped in the fifth positioning groove 1811, and a third buckle point 18111 will block the hook to prevent the rubber jig from falling off. To remove a rubber jig, the hook is pulled out of the fifth positioning groove 1811 to disengage the hook from the third buckle point 18111, and the rubber jig can be removed.

The third fishing gear rack 17 and the fourth fishing gear rack 18 are arranged in the box body 1, the third fishing gear rack 17 can be used to neatly hold a plurality of jig heads 19, the fourth fishing gear rack 18 can be used to neatly hold a plurality of rubber jigs, and the jig heads 19 and the rubber jigs are not easy to drop.

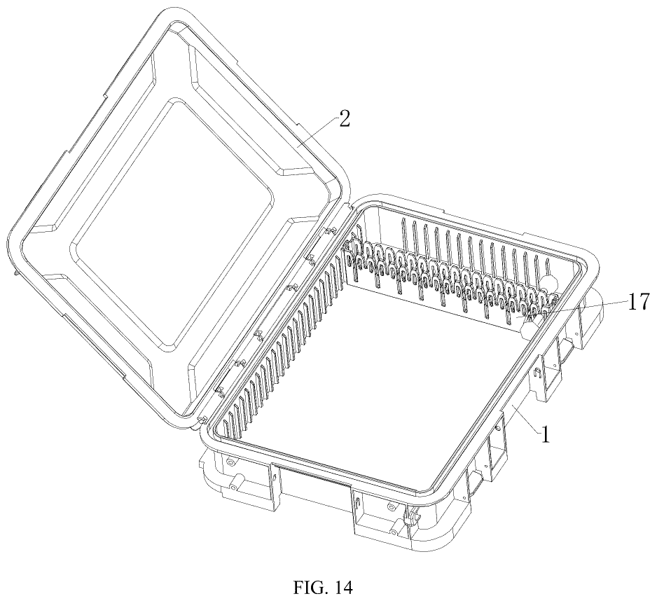

Embodiment 7: As shown in FIG. 14, embodiment 7 is different from embodiment 6 in that: only a third fishing gear rack 17 is installed in embodiment 7, without a fourth fishing gear rack 18.

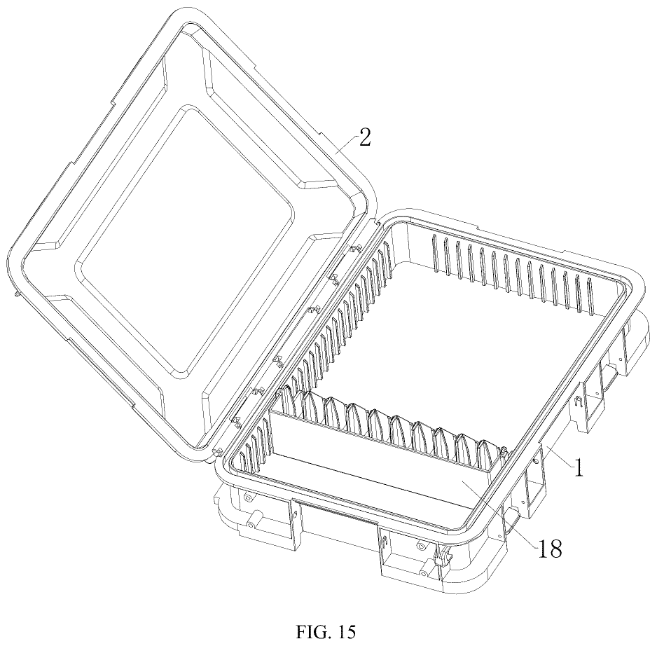

Embodiment 8: As shown in FIG. 15, embodiment 8 is different from embodiment 6 in that: only a fourth fishing gear rack 18 is installed in embodiment 8, without a third fishing gear rack 17.

Of course, the above only describes the preferred embodiments of the present invention, and does not limit the scope of the patent of the present invention. For example, in FIG. 11, the third fishing gear rack 17 and the fourth fishing gear rack 18 are installed by extending front and back, and the third fishing gear rack 17 and the fourth fishing gear rack 18 of different lengths can be produced so that the third fishing gear rack 17 and the fourth fishing gear rack 18 can be installed by extending left and right. For example, the fourth fishing gear rack 18 can be used to hold the same type of artificial baits as rubber jigs. All simple modifications and equivalent structural changes made by using the description and schematic content of the present invention shall be included within the protection scope of the patent of the present invention in the same way.

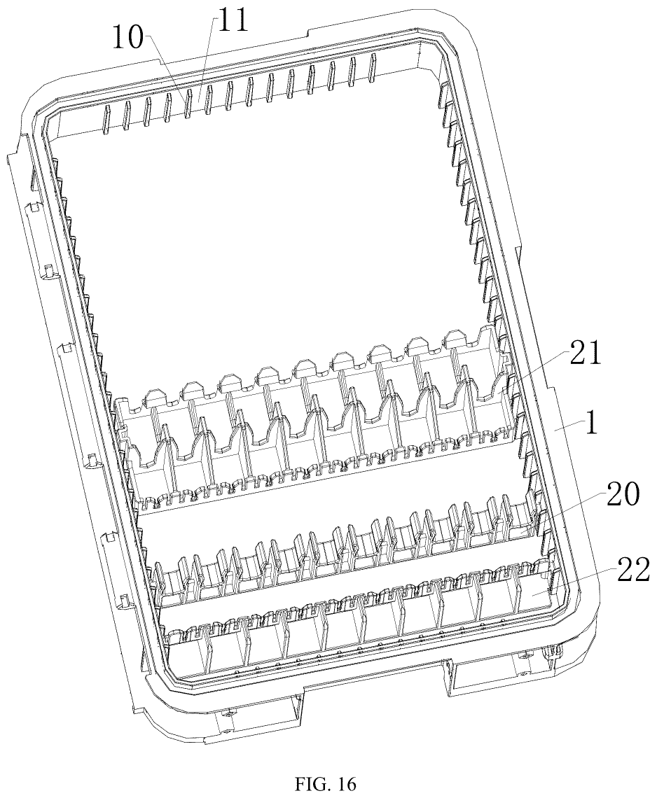

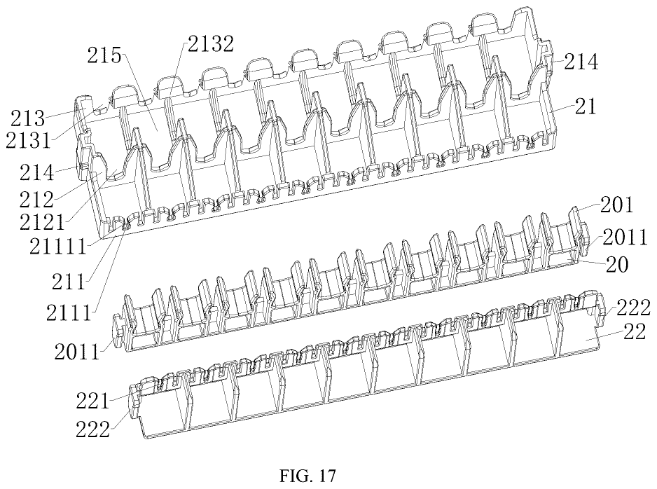

Embodiment 9: As shown in FIG. 16 and FIG. 17, a fishing gear storage box comprises a box body 1, protruding strips 1011 are convexly arranged on the front, rear, left and right inner walls of the box body 1 respectively, grooves 11 are formed between adjacent protruding strips 1011, and a fifth fishing gear rack 20 and a sixth fishing gear rack 21 are detachably installed in the box body 1.

The fifth fishing gear rack 20 is detachably connected with the grooves 11, and the upper end of the fifth fishing gear rack 20 is provided with a plurality of fixing clips 201 distributed left and right.

The sixth fishing gear rack 21 is detachably connected with the grooves 11, the sixth fishing gear rack 21 comprises a fifth clamping plate 211, a sixth clamping plate 212 and a seventh clamping plate 213 distributed from front to back, the fifth clamping plate 211 is provided with a plurality of first mounting grooves 2111 distributed left and right, the sixth clamping plate 212 is provided with a plurality of second mounting grooves 2121 distributed left and right, the seventh clamping plate 213 is provided with a plurality of third mounting grooves 2131 distributed left and right, the front ends, the rear ends and the upper ends of the first mounting grooves 2111, the second mounting grooves 2121 and the third mounting grooves 2131 are all open, and the second mounting grooves 2121 are arranged in alignment with the first mounting grooves 21111 and the third mounting grooves 2131.

A seventh fishing gear rack 22 is detachably installed in the box body 1, the seventh fishing gear rack 22 is located in front of the fifth fishing gear rack 20, the seventh fishing gear rack 22 is provided with a plurality of fourth mounting grooves 221 distributed left and right, the front ends, the rear ends and the upper ends of the fourth mounting grooves 211 are all open, and the fourth mounting grooves 221 are arranged in alignment with the fixing clips 201. The fixing clips 201 of the fifth fishing gear rack 20 can be used separately to champ metal jigs or in combination with the seventh fishing gear rack 22, and the combined use is for longer metal jigs, where one end can be clamped in the fixing clips 201 and the other end is clamped in the fourth mounting groove 221.

To facilitate the installation and removal of the fifth fishing gear rack 20, the sixth fishing gear rack 21 and the seventh fishing gear rack 22, the left end and the right end of the fifth fishing gear rack 20 are convexly provided with third clamping strips 2011, the left end and the right end of the sixth fishing gear rack 21 are convexly provided with fourth clamping strips 214, the left end and the right end of the seventh fishing gear rack 22 are convexly provided with fifth clamping strips 222, and the grooves 11 are for the third clamping strips 2011, the fourth clamping strips 214 and the fifth clamping strips 222 to be clamped in.

The sixth fishing gear rack 21 is provided with a second containing groove 215 with an upward opening, the second containing groove 215 is extended from the left end to the right end of the sixth fishing gear rack 21, and the second containing groove 215 is located between the sixth clamping plate 212 and the seventh clamping plate 213.

As shown in FIG. 17, fourth buckle points 21111 are arranged in the upper end of the first mounting groove 2111, and the fourth buckle points 21111 are used to block the hooks of rubber jigs.

The sixth fishing gear rack 21 is used to hold rubber jigs, and the heads of the rubber jigs can be placed in the second containing groove 215. To place a rubber jig, the head thereof is placed in the second containing groove 215 (the head of a rubber jig refers to a jig head of the rubber jig), one end of the hook is clamped in the second mounting groove 2121, the other end of the hook is clamped in the first mounting groove 2111, and the fourth buckle point 21111 will block the hook to prevent the rubber jig from falling off. To remove a rubber jig, the hook is pulled out of the first mounting groove 2111 to disengage the hook from the fourth buckle point 21111, and the rubber jig can be removed. For rubber jigs with sequins, sequins can be clamped in the third mounting grooves 2131.

As shown in FIG. 17, the upper end of the seventh clamping plate 213 is provided with a plurality of stoppers 2132 distributed left and right, and the stoppers 2132 are extended forwards above the second containing groove 215. The stoppers 2132 are used to block the heads of rubber jigs in the second containing groove 215, and the stoppers 2132 can be placed above the heads of the rubber jigs to prevent the heads of the rubber jigs from sliding out.

To sum up, the present invention can make various combinations of the fishing gear racks according to different fishing environments, fish species, fishing habits, etc. Compared with common single fishing gear boxes or fishing gear boxes with fishing gear disorderly placed, the present invention has high adaptability and diverse combined modes, which can meet the carrying requirements of different fishing baits. The combined modes absolutely can be matched according to the environment and personal preferences.

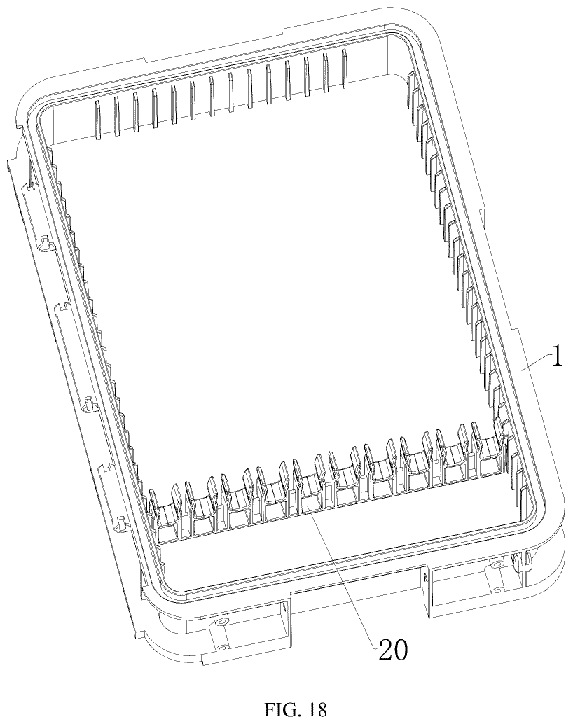

Embodiment 10: As shown in FIG. 18, embodiment 10 is different from embodiment 9 in that: only a fifth fishing gear rack 20 is installed in embodiment 10, without a sixth fishing gear rack 21 or a seventh fishing gear rack 22.

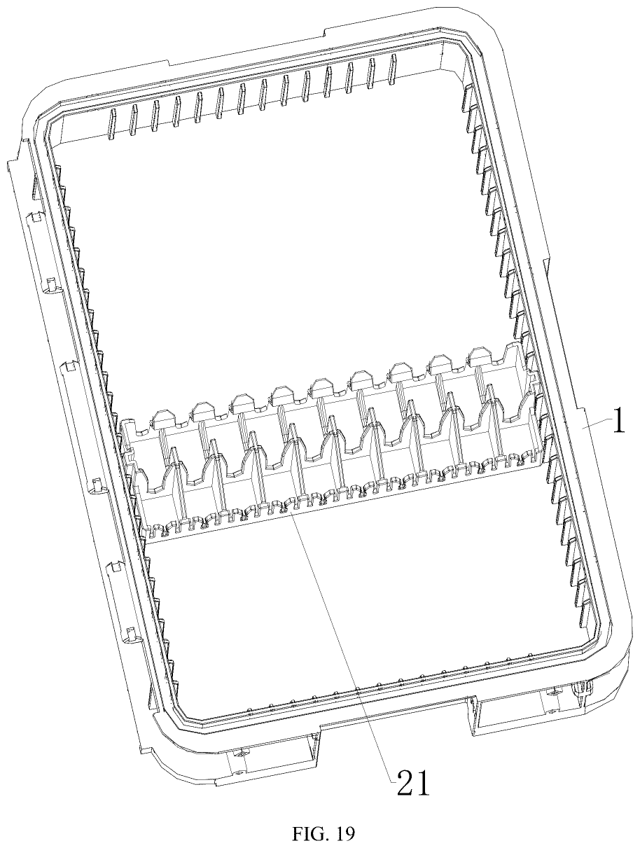

Embodiment 11: As shown in FIG. 19, embodiment 11 is different from embodiment 9 in that: only a sixth fishing gear rack 21 is installed in embodiment 11, without a fifth fishing gear rack 20 or a seventh fishing gear rack 22.

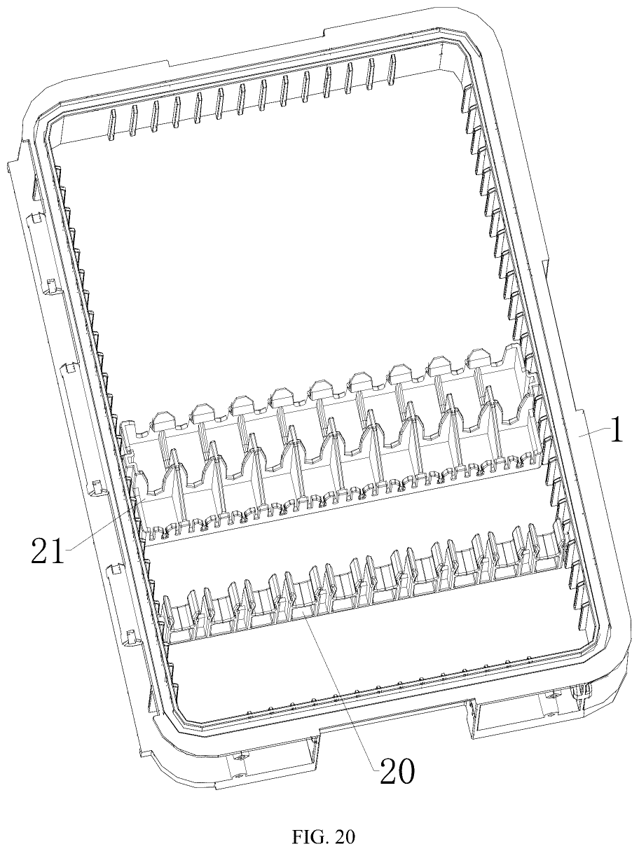

Embodiment 12: As shown in FIG. 20, embodiment 12 is different from embodiment 9 in that: only a fifth fishing gear rack 20 and a sixth fishing gear rack 21 are installed in embodiment 12, without a seventh fishing gear rack 22.

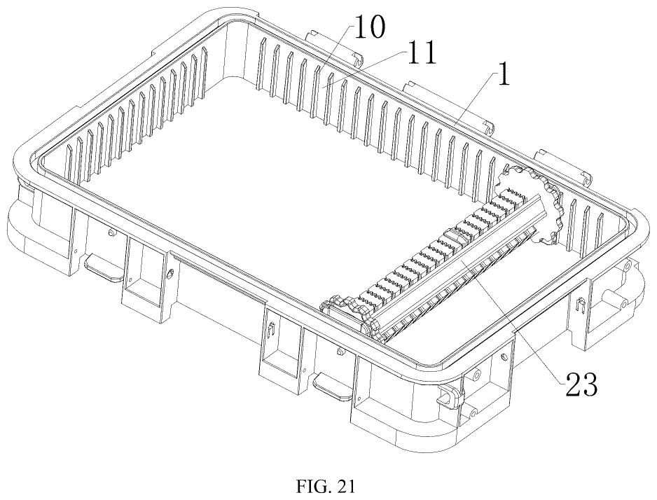

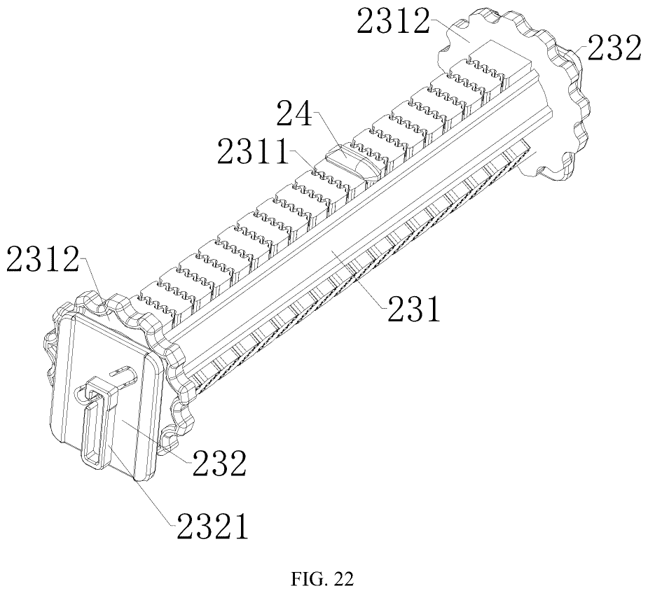

Embodiment 13: As shown in FIG. 21 to FIG. 23, a fishing gear storage box comprises a box body 1, protruding strips 10 are convexly arranged on the front, rear, left and right inner walls of the box body 1 respectively, grooves 11 are formed between adjacent protruding strips 10, an eighth fishing gear rack 23 is installed in the box body 1, the left end and the right end of the eighth fishing gear rack 23 are respectively provided with a sixth clamping strip 2321, and the sixth clamping strips 2321 are clamped in the grooves 11. The eighth fishing gear rack 23 comprises a bracket 231, and a plurality of rows of second clamping grooves 2311 for clamping fly tying hooks 24 are distributed on the outer wall of the bracket 231. The left end and the right end of the bracket 231 are respectively provided with a turntable 2312, the outer sides of the two turntables 2312 are respectively provided with a fixing plate 232, and the turntables 2312 are rotatably connected with the fixing plates 232. The sixth clamping strips 2321 are convexly arranged on the outer sides of the fixing plates 232. The bracket 231 is circular, the number of the second clamping grooves 2311 is four rows, and the four rows of second clamping grooves 2311 are evenly distributed on the outer wall of the bracket 231 along the circumference.

The outer wall of the bracket 231 is made of silica gel, which makes fly tying hooks more reliable and less likely to fall off than conventional carriers with a spongy structure.

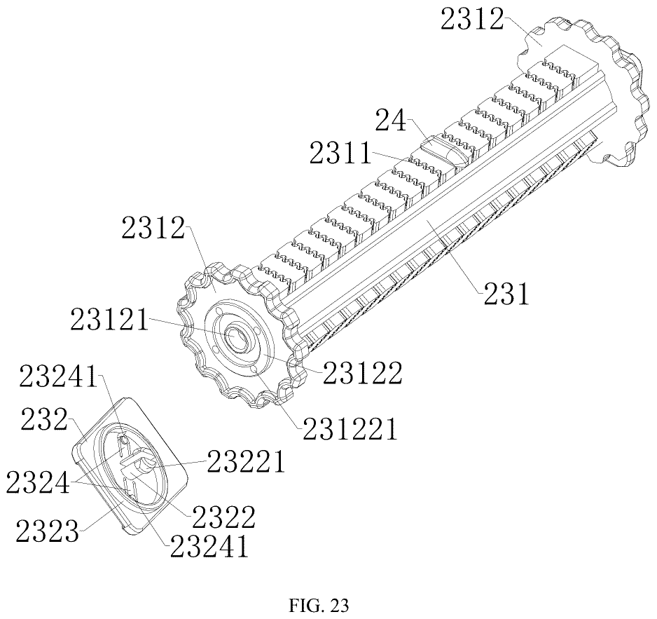

As shown in FIG. 23, to facilitate the rotation of the bracket 231, the inner sides of the two fixing plates 232 are respectively provided with an insertion column 2322 extending left and right, the centers of the two turntables 2312 are respectively provided with an insertion hole 23121 extending left and right, and the insertion column 2322 is inserted into the insertion hole 23121 and rotatably matched with the insertion hole 23121.

As shown in FIG. 23, to prevent the fixing plates 232 from falling off, the ends of the insertion column 2322 are provided with buckles 23221, and the buckles 23221 are clamped on the inner wall of the insertion hole 23121.

As shown in FIG. 23, the outer sides of the two turntables 2312 are respectively provided with a first convex ring 23122, the inner sides of the two fixing plates 232 are respectively provided with a second convex ring 2323, and the second convex ring 2323 is sleeved outside the first convex ring 23122. A plurality of circular grooves 231221 are evenly distributed on the outer wall of the first convex ring 23122 along the circumference, each fixing plate 232 is provided with two resilient pieces 2324, the inner sides of the two resilient pieces 2324 are convexly provided with a resilient point 23241 respectively, and the circular grooves 231221 are for the resilient points 23241 to be clamped in. The number of the circular grooves 231221 is two, the two resilient points 23241 are clamped in the two circular grooves 231221, and the resilient points 23241 are hemispherical. After the resilient points 23241 are clamped in one circular groove 231221, the bracket 231 is locked and is not easy to shake. After the bracket 231 is rotated by hand, the resilient points 23241 will move out of the circular groove 231221, the resilient pieces 2324 will deform until the resilient points 23241 are clamped in the other circular groove 231221, and the rotation is completed.

With the arrangement of a plurality of rows of second clamping grooves 2311 for clamping fly tying hooks 24 on the outer wall of the bracket 231, the fly tying hooks 24 can be placed neatly and orderly, which avoids the problem of messy placement of fly tying hooks 24 in traditional fixed partitioned storage, making the storage more tidy and facilitating users to quickly find the fly tying hooks 24 required; and the space utilization rate is high, the bracket 231 can be rotated, and when users need to take out fly tying hooks 24 placed in different positions, only the eighth fishing gear rack 23 needs rotating, without the need to turn over the entire storage box or change the placement direction thereof, which greatly improves the convenience of taking out the fly tying hooks 24.

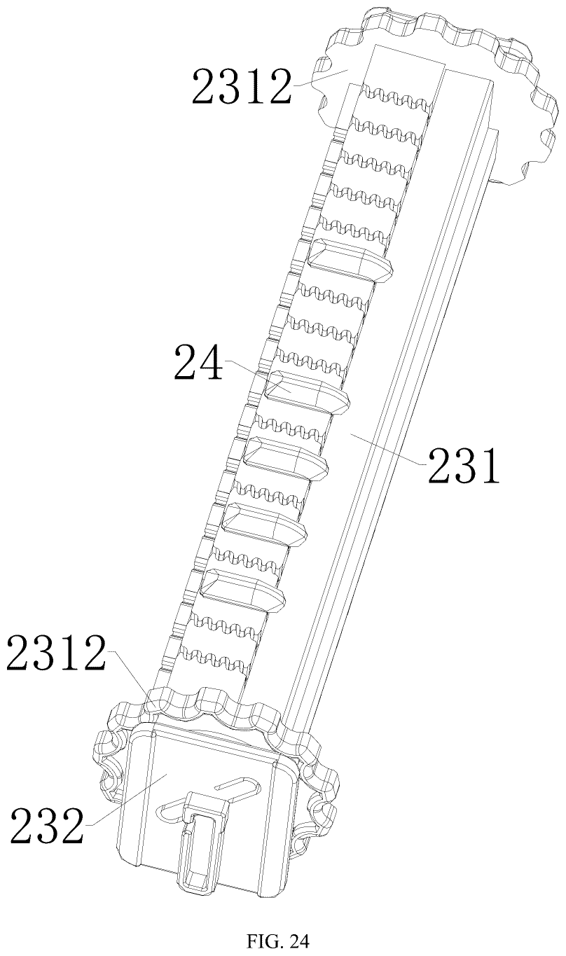

Embodiment 14: As shown in FIG. 24, embodiment 14 is different from embodiment 13 in that: an eighth fishing gear rack 23 in embodiment 14 is square, and the number of second clamping grooves 2311 is three rows.

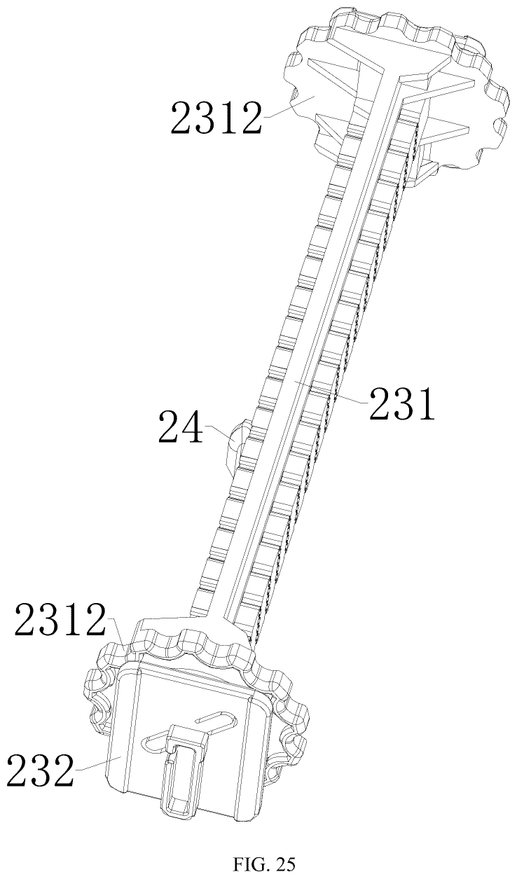

Embodiment 15: As shown in FIG. 25, embodiment 15 is different from embodiment 13 in that: an eighth fishing gear rack 23 in embodiment 15 is square, and the number of second clamping grooves 2311 is two rows.

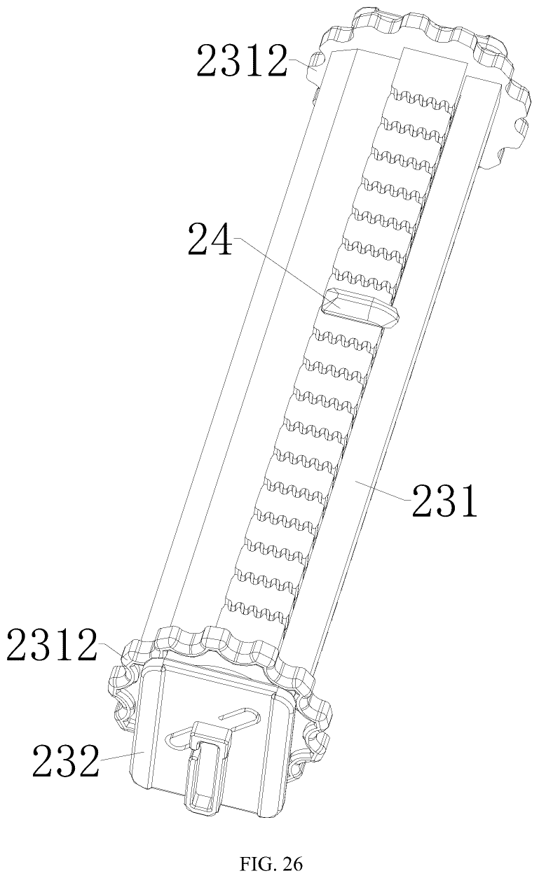

Embodiment 16: As shown in FIG. 26, embodiment 16 is different from embodiment 13 in that: an eighth fishing gear rack 23 in embodiment 16 is triangular, and the number of second clamping grooves 2311 is three rows.

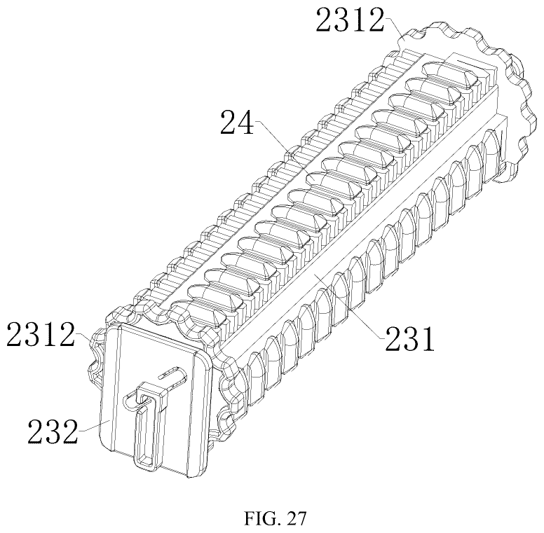

Embodiment 17: As shown in FIG. 27, embodiment 17 is different from embodiment 13 in that: an eighth fishing gear rack 23 in embodiment 17 is square, and the number of second clamping grooves 2311 is four rows.

The combined modes of the fishing gear racks in the box body in the technical solution of the present invention are not limited to the above technical solution, and the fishing gear racks can be used in combination and can be matched into appropriate modular combinations according to fishing environments, fishing habits and selection of fish species.

What is claimed is:

1. A fishing gear storage box, comprising a storage box body, wherein the storage box body has a single structure or a multi-layer structure formed by a plurality of storage box bodies spliced and combined together, the storage box body comprises a box body and a flip cover rotatably connected to the upper end of the box body, and one or a plurality of freely combinable fishing gear racks are detachably installed in the box body.

2. The fishing gear storage box according to claim 1, wherein protruding strips are convexly arranged on the front, rear, left and right inner walls of the box body respectively, grooves are formed between adjacent protruding strips, the upper ends of the grooves are open, both ends of the fishing gear rack are convexly provided with a clamping strip respectively, and the grooves are for the clamping strips to be clamped in.

3. The fishing gear storage box according to claim 2, wherein a first fishing gear rack is detachably installed in the box body, the first fishing gear rack is provided with a plurality of first clamping grooves with upward openings, the first fishing gear rack is composed of a base and soft rubber fixed on the base, and the first clamping grooves are arranged on the soft rubber.

4. The fishing gear storage box according to claim 3, wherein a second fishing gear rack is detachably installed in the box body, the second fishing gear rack is composed of a first placing rack and a second placing rack, the first placing rack is provided with a plurality of separation cavities with upward openings, and the second placing rack is provided with a plurality of notches facing upwards and separation grooves located to the right of the notches; and the upper end of the first placing rack is hinged with a pressure plate for blocking the openings at the upper ends of the separation cavities;
both ends of the first fishing gear rack, both ends of the first placing rack and both ends of the second placing rack are convexly provided with a clamping strip respectively, and the grooves are for the clamping strips to be clamped in.

5. The fishing gear storage box according to claim 1, wherein the outer side of the box body is convexly provided with a plurality of mounting columns;
the left side and the right side of the front end of the box body are respectively provided with a belt hole, and the two belt holes are used to hang belts;
the left end, the right end and the front end of the box body are respectively provided with a flip cover buckle for clamping the flip cover, and a buckle groove for the outer edge of the flip cover to be clamped in is formed between the inner side of the flip cover buckle and the top of the box body.

6. The fishing gear storage box according to claim 1, wherein the front end and the rear end of the flip cover are respectively provided with clamping holes and bayonets, the rear lower end of the box body is provided with first clamping hooks, the front end of the box body is hinged with buttons, the lower end of each button is provided with a second clamping hook, and when the storage box body has a multi-layer structure formed by a plurality of storage box bodies spliced and combined together, the first clamping hooks and the second clamping hooks of the box body of one of the two adjacent storage box bodies are respectively clamped in the clamping holes and the bayonets of the flip cover of the other storage box body.

7. The fishing gear storage box according to claim 2, wherein a third fishing gear rack is detachably installed in the box body, the third fishing gear rack comprises a first clamping plate and a second clamping plate located to the left of the first clamping plate, the first clamping plate is provided with a plurality of first positioning grooves and second positioning grooves, the left ends, the right ends and the upper ends of the first positioning grooves and the second positioning grooves are all open, the first positioning grooves and the second positioning grooves are evenly spaced from front to back, the inner wall of the upper end of each first positioning groove is convexly provided with first buckle points, the second clamping plate is provided with a plurality of third positioning grooves and fourth positioning grooves, the left ends, the right ends and the upper ends of the third positioning grooves and the fourth positioning grooves are all open, the third positioning grooves and the fourth positioning grooves are evenly spaced from front to back, the inner wall of the upper end of each fourth positioning groove is convexly provided with second buckle points, the first positioning grooves are arranged in alignment with the third positioning grooves, and the second positioning grooves are arranged in alignment with the fourth positioning grooves.

8. The fishing gear storage box according to claim 7, wherein a fourth fishing gear rack is detachably installed in the box body, the fourth fishing gear rack comprises a third clamping plate and a fourth clamping plate located to the left of the third clamping plate, the third clamping plate is provided with a plurality of fifth positioning grooves distributed front and back, the fourth clamping plate is provided with a plurality of sixth positioning grooves distributed front and back, the fifth positioning grooves are arranged in alignment with the sixth positioning grooves, and the left ends, the right ends and the upper ends of the fifth positioning grooves and the sixth positioning grooves are all open.

9. The fishing gear storage box according to claim 7, wherein a partition plate extending front and back is arranged in the third fishing gear rack, and the partition plate is located between the first clamping plate and the second clamping plate.

10. The fishing gear storage box according to claim 8, wherein the fourth fishing gear rack is provided with a first containing groove with an upward opening, and the first containing groove is located to the left of the fourth clamping plate.

11. The fishing gear storage box according to claim 2, wherein a fifth fishing gear rack is detachably installed in the box body, the fifth fishing gear rack is detachably connected with the grooves, and the upper end of the fifth fishing gear rack is provided with a plurality of fixing clips distributed left and right.

12. The fishing gear storage box according to claim 11, wherein a sixth fishing gear rack is detachably installed in the box body, the sixth fishing gear rack is detachably connected with the grooves, the sixth fishing gear rack comprises a fifth clamping plate, a sixth clamping plate and a seventh clamping plate distributed from front to back, the fifth clamping plate is provided with a plurality of first mounting grooves distributed left and right, the sixth clamping plate is provided with a plurality of second mounting grooves distributed left and right, the seventh clamping plate is provided with a plurality of third mounting grooves distributed left and right, the front ends, the rear ends and the upper ends of the first mounting grooves, the second mounting grooves and the third mounting grooves are all open, and the second mounting grooves are arranged in alignment with the first mounting grooves and the third mounting grooves.

13. The fishing gear storage box according to claim 12, wherein a seventh fishing gear rack is detachably installed in the box body, the seventh fishing gear rack is located in front of the fifth fishing gear rack, the seventh fishing gear rack is provided with a plurality of fourth mounting grooves distributed left and right, the front ends, the rear ends and the upper ends of the fourth mounting grooves are all open, and the fourth mounting grooves are arranged in alignment with the fixing clips.

14. The fishing gear storage box according to claim 13, wherein the left end and the right end of the fifth fishing gear rack are convexly provided with third clamping strips, the left end and the right end of the sixth fishing gear rack are convexly provided with fourth clamping strips, the left end and the right end of the seventh fishing gear rack are convexly provided with fifth clamping strips, and the grooves are for the third clamping strips, the fourth clamping strips and the fifth clamping strips to be clamped in;
the sixth fishing gear rack is provided with a second containing groove with an upward opening, the second containing groove is extended from the left end to the right end of the sixth fishing gear rack, and the second containing groove is located between the sixth clamping plate and the seventh clamping plate;
the upper end of the seventh clamping plate is provided with a plurality of stoppers distributed left and right, and the stoppers are extended forwards above the second containing groove.

15. The fishing gear storage box according to claim 2, wherein an eighth fishing gear rack is installed in the box body, the left end and the right end of the eighth fishing gear rack are respectively provided with a sixth clamping strip, and the sixth clamping strips are clamped in the grooves; the eighth fishing gear rack comprises a bracket, and a plurality of rows of second clamping grooves for clamping fly tying hooks are distributed on the outer wall of the bracket; the left end and the right end of the bracket are respectively provided with a turntable, the outer sides of the two turntables are respectively provided with a fixing plate, and the turntables are rotatably connected with the fixing plates; and the sixth clamping strips are convexly arranged on the outer sides of the fixing plates.

16. The fishing gear storage box according to claim 15, wherein the inner sides of the two fixing plates are respectively provided with an insertion column extending left and right, the centers of the two turntables are respectively provided with an insertion hole extending left and right, and the insertion column is inserted into the insertion hole and rotatably matched with the insertion hole.

17. The fishing gear storage box according to claim 16, wherein the ends of the insertion column are provided with buckles, and the buckles are clamped on the inner wall of the insertion hole.

18. The fishing gear storage box according to claim 17, wherein the outer sides of the two turntables are respectively provided with a first convex ring, the inner sides of the two fixing plates are respectively provided with a second convex ring, and the second convex ring is sleeved outside the first convex ring.

19. The fishing gear storage box according to claim 18, wherein a plurality of circular grooves are evenly distributed on the outer wall of the first convex ring along the circumference, each fixing plate is provided with two resilient pieces, the inner sides of the two resilient pieces are convexly provided with a resilient point respectively, and the circular grooves are for the resilient points to be clamped in.
